(19) United States
(12) Patent Application Publication
(10) Pub. No.: US 2005/0150528 A1
(43) Pub. Date: Jul. 14, 2005

(54) Dish washing machine

(75) Inventor: Young Soo Kim, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/017,812

(22) Filed: Dec. 22, 2004

(30) Foreign Application Priority Data
Dec. 26, 2003 (KR) 97836/2003
Dec. 26, 2003 (KR) 97837/2003

(51) Int. Cl. B08B 3/02

(52) U.S. Cl. 134/108; 134/135; 134/179; 211/41.3; 134/198

(57) ABSTRACT

A dish washing includes a cabinet having a washing room formed in the cabinet to receive dishes, an injection arm for injecting a washing water toward the dishes, and many components contacted with the washing water. In order to improve the utilization efficiency of the dish washing machine, the machine also includes a plasma coating layer formed on an outer surface of each of the components, a heater for heating the washing water, an air ventilation hole for discharge humid air while the dishes are dried, and a discharge fan for forcibly flowing air through the air ventilation hole.

### BACKGROUND OF THE INVENTION

1. Field of the Invention

The present invention relates to a dish washing machine, and more particularly to a dish washing machine that prevents contamination caused by food remnants generated while the dish washing machine is in use so as to improve cleanness of the dish washing machine and the dishes therein, and also prevents bad smell generated by spoiling of the food remnants.

2. Description of the Related Art

A dish washing machine is generally a device for removing food remnants adhered to dishes by forcibly injecting a detergent-diluted washing water to the dishes. Such a dish washing machine is recently spread wider for better convenience of home life.

Meanwhile, the dish washing machine includes many components. In detail, the dish washing machine includes a washing water circulation unit for compressing and circulating a washing water, a washing water injection unit for injecting the washing water toward dishes, a shelf for allowing dishes to be stably seated in an inner space of the washing machine, a filter unit for collecting food remnants contained in the washing water, a heating unit for heating the washing water to improve the washing efficiency, and an air circulation unit for supplying an open air while a drying cycle is progressed. In addition to them, a water supply unit and a detergent inputting unit may be further included.

Now, operation of the dish washing machine is described.

If a washing water is supplied, the washing water injection unit injects the washing water toward dishes at high pressure, and the injected washing water then washes food remnants adhered to the dishes. In addition, the washed food remnants are filtered by the filter unit and then removed separately, and the washing water circulation unit then regenerates a washing water and supplies it again to the washing water injection unit. In addition, the heating unit may heat the washing water over a certain temperature so as to improve the washing efficiency.

In addition, the shelf supports the dishes so that the dishes are not fallen down and broken even when the washing water is injected toward the dishes at high pressure.

Moreover, after completing a series of works such as washing and rinsing of dishes, an open air is introduced in by means of the air circulation unit, and the introduced open air removes moisture remained on the dishes to progress a dish drying cycle. Furthermore, the heating unit may be also operated so that the drying cycle is more rapidly progressed.

However, the related art dish washing machine may act as a factor of bad smell since food remnants separated from the dishes are adhered to each component of the dish washing machine such as a sump or an inner wall of the machine, and then spoiled.

In addition, in order to eliminate the food remnants, a factor of bad smell, a user should clean the wash dishing machine periodically. Moreover, a user should clean inside of the dish washing machine with a sterilizer in order to eliminate bacteria in the dish washing machine, which is harmful for hygiene of home.

Meanwhile, a water drop formed on the shelf may be dropped down to the dishes during the dish drying cycle. If such dropped water is evaporated after the drying cycle is progressed, a print of the water is remained to give displeasure to a user though it is not a contaminant. Furthermore, if a water drop is formed on the shelf, it takes more time for the drying cycle, thereby consuming more energy. Thus, it is required to shorten the dish drying cycle so as to reduce energy consumption.

### SUMMARY OF THE INVENTION

The present invention is designed to solve the problems of the prior art, and therefore an object of the invention is to provide a dish washing machine that is capable of restraining propagation of bacteria and eliminating bad smell by conducting a certain treatment on surface and inside of components of the dish washing machine when the machine is manufactured.

Another object of the invention is to provide a dish washing machine capable of cleaning environments of a kitchen more clearly since the dish washing machine, which was a hotbed of bacteria, gives antibacterial ability by itself.

Still another object of the invention is to provide a dish washing machine capable of reducing energy consumed for operation of the machine and improving cleanness of dish surfaces after the overall operation of the machine is completed.

In order to accomplish the above object, the dish washing machine according to the present invention includes a cabinet having a washing room for receiving dishes therein; an injection arm for injecting a washing water toward the dishes; components positioned in the cabinet and contacted with the washing water; a plasma coating layer formed on an outer surface of the components; a heater for heating the washing water; a air ventilation hole for discharging humid air when the dishes are dried; and a discharge fan for forcibly flowing air through the air ventilation hole.

In another aspect of the invention, there is provided a dish washing machine, which includes a shelf placed in an inner space of the dish washing machine so that spoons and/or dishes are seated thereon; and a hydrophilic plasma coating layer formed on an outer surface of the shelf.

In still another aspect of the invention, there is also provided a dish washing machine, which includes a cabinet for forming a washing room to wash dishes; a shelf for receiving dishes; an injection arm for injecting a washing water toward the dishes; a contaminant collector positioned below the washing room to collect contaminants from the washing water that is flowed thereto, the contaminant collector being coated with at least silver and/or titanium oxide and/or copper coating layer; an air ventilation hole for discharging air generated by action of the coating layer; and a discharge fan for discharging the air through the air ventilation hole.

In further another aspect of the invention, there is also provided a dish washing machine, which includes a cabinet for forming a washing room to wash dishes; an inner panel provided to an inner circumference of the cabinet; a shelf for containing dishes; an injection arm for injecting a washing water toward the dishes; a sump for collecting water discharged from the injection arm; and a filter for filtering contaminants from the water collected in the sump, wherein at least one component of the inner panel, the shelf, the injection arm, the sump and the filter is made of nano-poly.

The proposed configuration may give an effect of improving hygiene of environments of a kitchen. In addition, the present invention may give effects of eliminating bad smell generated by spoiling of food remnants, thereby giving better agreeable feeling to a user.

Moreover, a time required for the drying cycle is shortened, and thus energy consumption is also decreased. In addition, a print remained on the dish after washing may be completely eliminated, thereby further improving the agreeableness of the user.

### BRIEF DESCRIPTION OF THE DRAWINGS

The present invention will be more clearly understood with reference to the accompanying drawings.

FIG. 1 is a perspective view showing a dish washing machine according to the spirit of the present invention;

FIG. 2 is a perspective view showing a shelf of the dish washing machine according to the present invention;

FIG. 3 is a sectional view showing a plasma coating layer forming device for forming a plasma coating layer on a surface of a component made of plastic; and

FIG. 4 is a sectional view showing a plasma coating layer forming device for forming a plasma coating layer on a surface of a component made of conductive metal.

### DETAILED DESCRIPTION OF THE INVENTION

Hereinafter, a specific embodiment of the present invention is described in detail with reference to the accompanying drawings. However, the spirit of the invention is not limited to the accompanying drawings and relevant embodiment, but those skilled in the art may easily propose other embodiments within the spirit of the invention, and these embodiments are considered to be included in the scope of the invention.

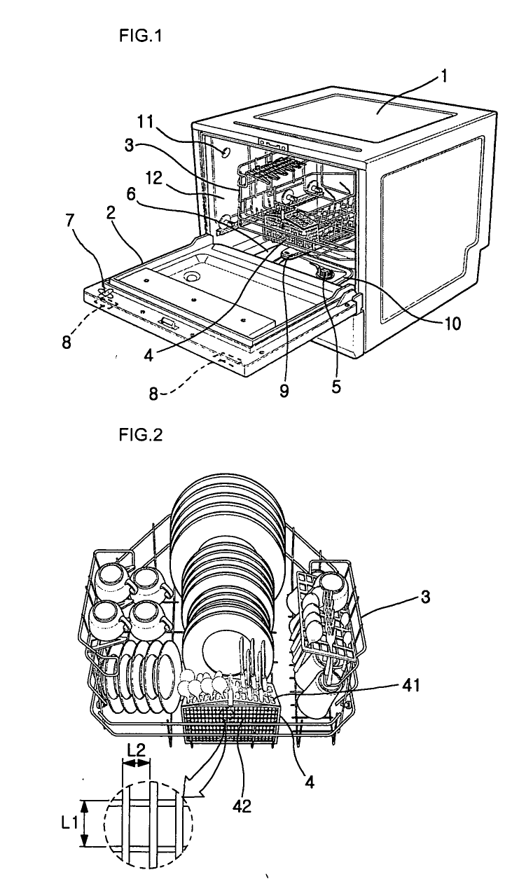

FIG. 1 is a perspective view showing a dish washing machine according to the spirit of the present invention.

Referring to FIG. 1, the dish washing machine of the present invention includes a cabinet 1 configuring an appearance of the dish washing machine, a dish shelf 3 and a spoon box 4 placed in the cabinet 1, a door 2 mounted to an opening formed in one side of the cabinet 1 so that dishes may be entered and exited through it, an inner panel 12 for forming an inner space of the dish washing machine, an injection arm 9 for injecting a washing water toward the dishes at high pressure, a sump 10 formed in a lower surface of the inner panel 12 to collect the water used for washing, a filter 5 for filtering food remnants separated from the dishes, a heater 6 mounted in the cabinet 1 to heat a washing water and/or an air, a discharge fan 7 for forcibly discharging and/or circulating a humid air in the inner space of the dish washing machine, an air ventilation hole 8 acting as a path for flowing out the air forcibly discharged by the discharge fan 7, and a lamp 11 for lightening an inside of the dish washing machine so that the inside of the dish washing machine may be easily observed.

In detail, the shelf includes a dish shelf 3 on which larger articles such as dishes are seated, and a spoon box 4 on which smaller articles such as spoons, chopsticks and forks are seated, as well shown in the perspective view of FIG. 2.

Referring to FIG. 2, it is shown that the shelf includes the dish shelf 3 on which heavy tableware such as cup and dish are placed, and the spoon box 4 seated on a predetermined place of the dish shelf 3 and on which light tableware such as spoons are placed. As shown in FIG. 2, since a great number of heavy tableware is placed on the dish shelf 3, the dish shelf 3 is preferably made of strong material such as steel. Of course, many kinds of seating parts with various shapes may be formed to the shelf in various ways according to the kind of the tableware.

In addition, the spoon box 4 includes a spoon placing portion 41 forming an upper part of the spoon box 4 and having spoon placing holes, and a frame 42 extended below the spoon placing portion 41 to form each sidewall. In particular, the frame 42 has a rectangular lattice shape in which a plurality of horizontal rods and a plurality of vertical rods are crossed on the basis of the ground, and gaps (L1) of the horizontal rods are wider than gaps (L2) of the vertical rods. Such shape of the frame 42 helps the washing water to be dropped down by gravity without any obstacle. In detail, if the gaps (L1) of the horizontal rods are wider than the gaps (L2) of the vertical rods, the washing water tends to flow down along the vertical rods rather than to remain on the horizontal rods, so the washing water may be rapidly flowed down in a gravity direction.

In addition, the dish shelf 3 is made of metal with high strength in order to support loads of heavy dishes, and its outer surface is further made of plastic. Due to the configuration of the dish shelf 3, the outer surface of the dish shelf 3 exposed to moisture may become waterproof, thereby capable of being used for a longer time. Moreover, a hydrophilic functional coating layer is formed on the shelf 3 and 4 so that a water drop is not formed on the surface of the shelf 3 and 4, thereby shortening the drying cycle and preventing impurities from being remained on the surface of dishes.

As mentioned above, the hydrophilic functional coating layer is further formed on the surfaces of the dish shelf 3 and the spoon box 4. Now, a function of the hydrophilic functional coating layer is described, and the process of forming the hydrophilic coating layer is described later. A shelf on which a hydrophilic coating layer is formed shows a substantially zero contact angle to water due to the hydrophilic coating, differently from the properties of the shelf 3 and 4 itself, so water is instantly dispersed and then directly dropped down though it contacts with the surface of the shelf. That is to say, the water contacted with the surface of the shelf 3 and 4 does not form a water drop due to the hydrophilic coating but is flowed down by gravity. Thus, water is not adhered to the surface of the shelf 3 and 4 during the washing and rinsing processes of the dish washing machine, so a water drop is not dropped toward the dishes. Thus, the dishes may be kept clean without a print of water drop after the drying cycle of the dish washing machine is completed.

In detail, the inner panel 12 is made of plastic resin, and silver particles may be contained in the plastic resin as one component. These silver particles have the sterilizing and deodorizing functions, so they prevent food remnants adhered to the inner panel 12 from being spoiled so that bad smell and uncleanness are not generated due to decomposition of the food remnants. The sterilizing, antibacterial and deodorizing effects of silver are already well known in the art. In addition, inner components of the dish washing machine, which are possibly made of plastic resin, may contain silver particles within an allowable range so as to give the sterilizing, antibacterial and deodorizing effects.

In addition, in order to improve the antibacterial and deodorizing functions, a functional coating layer made of sterilizing/antibacterial/deodorizing material such as titanium oxide (TiO₂) and/or silver and/or copper may be further formed on the surface of the inner panel 12. Forming method, configuration and operation of the coating layer will be described later.

In detail, the injection arm 9 allows a washing water to be injected by the washing machine toward dishes seated on the shelf 3 and 4. The washing water is strongly injected by means of a pump (not shown) mounted to the bottom of the dish washing machine so as to clean food remnants adhered to the dishes. Since the injection arm 9 is also continuously exposed to food remnants, silver particles may be suitably contained in the plastic resin and a predetermined coating layer made of sterilizing/antibacterial/deodorizing materials may also be formed on the surface of the injection arm 9.

In detail, the sump 10 is depressed on a lower surface of the inner panel 12 to collect food remnants, and a washing water contaminated by washing is gathered to the sump 10. Thus, food remnants are always adhered to the sump 10, and the food remnants adhered thereto may be decomposed to generate bad smell, so sterilizing, antibacterial and deodorizing treatment is required to the sump 10. In addition, the filter 5 mounted near to a water gathering portion of the sump 10 is also frequently contaminated seriously, and requires sterilizing, antibacterial and deodorizing treatments. Thus, the sump 10 and the filter 5 are preferably made of nano-poly, and a sterilizing functional coating layer is also preferably formed on its outer surface to give a sterilizing function. In particular, the filter 5 may have not only the shape shown in the drawing but also other configurations such as a multi-layer filter. In addition, the sterilizing, antibacterial and deodorizing functions employed in the present invention may be applied to any kind of filter mounted in the washing water circulating path. The sump 10 and the filter 5 may be called a contaminant collector since a washing water is gathered thereto and contaminants are filtered from the gathered water there.

In detail, the heater 6 heats the washing water to improve utilization of detergent. In addition, when dishes are dried, the heater 6 heats air so that the dishes are dried more rapidly.

In detail, the air ventilation hole 8 and the discharge fan 7 are used for forming a path of airflow. Though it is shown that the air ventilation hole 8 and the discharge fan 7 are positioned to the door 2 in the drawings, they may be positioned in different positions such as on the cabinet 1, depending on its circumstance. In addition, though it is shown that the shelf 3 and 4 configures a single body of a single floor, the shelf 3 and 4 may be configured with multi floors.

Now, operation and action of the dish washing machine are described with reference to the above configuration.

A user opens the door 2 and then seats dishes on the shelf 3 and 4 in order to use the dish washing machine. After the dishes are seated thereon, the user pushes the shelf into the cabinet 1 and closes the door 2. After that, a series of washing and rinsing procedure is progressed.

When the washing and rinsing procedure is progressed, a washing water of high pressure is injected through the injection arm 9, and the washing water injected toward the dishes removes food remnants adhered to the dishes. The washing water containing food remnants is gathered on the sump 10, and then the food remnants are filtered by the filter 5. In addition, the washing water free from food remnants is generated by means of a predetermined circulation structure, and then guided to the injection arm 9 to conduct a role of washing water again. Of course, while the washing and rinsing work of the dish washing machine is conducted, the heater 6 may apply heat so that the washing water is heated.

After the dishes are washed and rinsed according to the above procedure, the dishes are dried. The dish drying cycle includes a heating process of generating heat continuously by the heat 6 to increase temperature of the inner space of the cabinet 1 and lower relative humidity so that an evaporating rate of water adhered to the dishes or the shelf is increased, and a discharging process of rapidly discharging humid air in the cabinet 1 to outside by using the discharge fan 7. However, the drying cycle may also be conducted just using only one of the heating process and the discharging process.

In particular, just before the dish drying cycle is progressed, a water drop is substantially not formed on the shelf 3 and 4 due to the hydrophilic coating layer, and already discharged out of the dish washing machine. Thus, there is remained a very small amount of water to be evaporated during the drying cycle. Since an amount of washing water to be evaporated is very small, the drying cycle of the dish washing machine may be more rapidly completed under the same condition, rather than a related art. As a result, it may be easily guessed that energy consumption is also decreased since an amount of washing water to be evaporated is small.

In addition, a very small amount of water is remained on the shelf 3 and 4, and the water is also dispersed due to the hydrophilic coating layer, not forming a water drop. Thus, while the dish drying cycle is progressed, a water drop is substantially not fallen down to the dishes. Since a water drop is not fallen down to the dishes, there is far little possibility that a print is remained on the surface of the dishes after the drying cycle.

Meanwhile, on the outermost portion of the dish shelf 3 and the spoon box 4, a hydrophilic functional coating layer is further formed as mentioned above. In addition, a functional coating layer for sterilization by silver, titanium and copper is formed on many components such as the inner panel 12, the sump 10 and the filter 5 in the dish washing machine, to which the washing water may be contacted. Hereinafter, the process of forming the hydrophilic coating layer is described.

First, configuration and method for forming the functional coating layer are described.

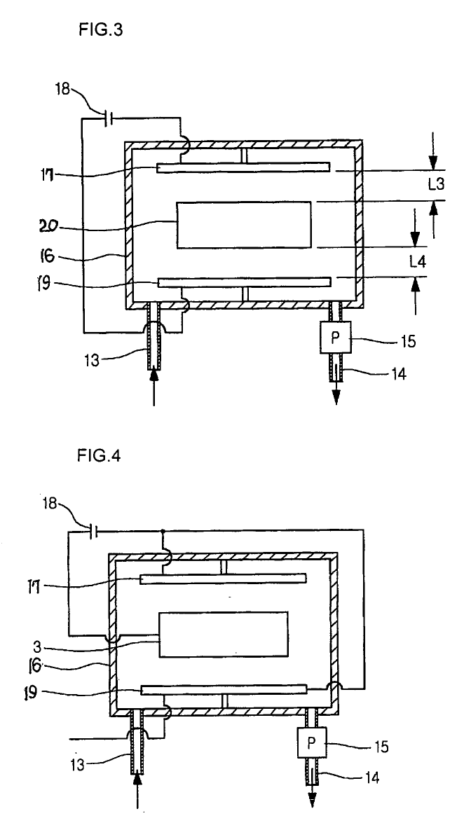

FIG. 3 shows a plasma coating layer forming device for forming a plasma coating layer on the surface of a component made of plastic. Meanwhile, in case that the component is made of plastic resin, silver particles may be contained in the plastic resin so that the component may give a sterilizing function by itself.

Referring to FIG. 3, the plasma coating layer forming device in this embodiment includes a vacuum chamber 16 for making its inside vacuous, upper and lower electrodes 17 and 19 mounted in the vacuum chamber 16 and supplied with high voltage to excite gas into a plasma state, a power source 18 for applying DC power to the upper and lower electrodes 17 and 19, a gas injection line 13 for injecting a predetermined gas into the vacuum chamber 16, and a discharge line 14 having a pump 15 to keep a vacuous state of the vacuum chamber 16. In addition, a non-conductive component 20 made of plastic is also placed in the vacuum chamber 16.

The non-conductive component 20 is preferably received in the vacuum chamber 16 after its shape is produced in order to improve perfection of the plasma coating layer. The non-conductive component 20 may be a component made of plastic such as the sump 10, the filter 5, the inner panel 12, the injection arm 9 and the spoon box 4 on which spoons are placed.

In detail, the gas introduced into the vacuum chamber may employ at least one sterilizing element of titanium oxide, silver and copper together with reaction gas such as oxygen, nitrogen, ammonia, carbon dioxide, steam and hydrogen. In order to obtain better plasma generating effects, the gas may be mixed with inert gas such as krypton, helium, neon, argon, and xenon, considering that oxygen has great ionizing energy.

To describe operation of the plasma generating device, the non-conductive component 20 is placed in the vacuum chamber 16, and an internal circumstance of the vacuum chamber 16 is adjusted. For example, the internal circumstance of the vacuum chamber 16 may be adjusted to a high vacuous state up to 1×10⁻⁶ Torr, a high voltage of 1,100V to 1,300V. Under this circumstance, the mixed gas introduced into the vacuum chamber 16 is excited to generate plasma, and this plasma forms a plasma coating layer on the outer surface of the non-conductive component 20.

Since the plasma coating layer is made of sterilizing material such as silver, titanium oxide and copper, the plasma coating layer may act as a sterilizing/antibacterial/deodorizing functional layer. In addition, the plasma coating layer formed on the outer surface of the spoon box 4 made of plastic becomes a hydrophilic functional coating layer due to material and coating manner of the coating layer, thereby facilitating water flow and improving cleanness of the dish washing machine.

Meanwhile, the plasma is preferably generated using DC power in consideration of productivity, though a high frequency generator up to several hundred watts may generate the plasma. However, using the high frequency generator is not excluded from the scope of the invention.

Preferably, a distance (L3) between the upper electrode 11 and the spoon box 4 and a distance (L4) between the lower electrode 12 and the spoon box 4 are at least 10 mm so that the functional coating layer may be uniformly and easily formed on the plastic component by plasma.

FIG. 4 shows a plasma coating layer forming device for forming a plasma coating layer on a surface of a component made of conductive metal according to the spirit of the present invention.

Referring to FIG. 4, the plasma coating layer forming device of this embodiment is identical to that of FIG. 3, except that a conductive component 21 is placed in the vacuum chamber 16 and (+) polar is connected to the conductive component 21 and (−) polar is connected to the upper and lower electrodes 17 and 19 in consideration of the conductive component 21. Since the wire is directly connected to the conductive component 21, a plasma coating layer forming efficiency is further improved.

The conductive component 21 may be any conductive component such as the dish shelf 3 and the circulation/discharge pump (not shown), and the device of FIG. 4 may conduct surface treatment of any component by plasma, if the component is conductive.

In addition, when the dish shelf 3 is placed in the vacuum chamber 16, it is preferred that a plastic coating layer is previously coated on the outer surface of the dish shelf 3 so that a hydrophilic coating layer may be effectively formed on the whole outer surface of the dish shelf 3. By using this configuration, an amount of washing water remained on the dish shelf 3 after the washing and rinsing work is decreased and a water drop is not fallen down from the dish shelf 3 after washing, like the spoon box 4.

Hereinafter, the sterilizing/antibacterial/deodorizing operation of silver, copper and titanium oxide is described. However, it is already well known in the art that silver and copper have the sterilizing and antibacterial properties, only operation of the titanium oxide is described in detail.

Titanium oxide primarily gives a physical deodorizing effect to remove bad smell by means of physical adsorption of smell-generating substances. Furthermore, a chemical deodorizing effect may also be expected.

In detail, if titanium oxide (TiO₂) is activated by ultraviolet energy emitted from an ultraviolet lamp, a positive hole (h⁺) and an electron (e⁻) are generated. And then, OH radical and O₂⁻ radical are generated by means of the positive hole and the electron, and various organic materials that are factor of spoiling and bad smell may be removed by means of oxidization. In more detail, carbon included in an organic material is oxidized into carbon dioxide (CO₂) and then discharged in the air, and hydrogen is oxidized into water (H₂O) and then discharged together with the washing water. Since the organic material is decomposed as mentioned above, the sterilizing/antibacterial/deodorizing operation is conducted.

In addition, the lamp 11 (see FIG. 1) may be an ultraviolet lamp so that titanium oxide may be activated. However, if the titanium oxide has a particle diameter smaller than a certain level, just a visible ray from such as an incandescent electric lamp may play a role of photo-catalyst without using an independent light source such as an ultraviolet lamp. Thus, the lamp 11 may employ a general lamp for allowing observation of the inside of the dish washing machine, not requiring a separate ultraviolet lamp as a light source. Meanwhile, in case that the lamp 11 is an ultraviolet lamp, it is not desirable due to a large amount of energy consumption. Thus, the ultraviolet lamp may be used for a longer time by intermittently turning on/off it according to the activation cycle of titanium oxide, together with improving the sterilizing/antibacterial/deodorizing functions.

Though it is described that titanium oxide, silver or copper forms the coating layer for the sterilizing/antibacterial/deodorizing action by plasma, it is also possible that the functional coating layer is formed by means of other methods such as chemical deposition or wet coating in order to conduct the aforementioned sterilizing/antibacterial/deodorizing functions. However, using plasma is most preferable to form the functional coating layer since the coating layer may be semi-permanently used.

Meanwhile, as an alternative method for the dish washing machine to accomplish the sterilizing/antibacterial/deodorizing functions, it is also possible that plastic itself contains silver. That is to say, a predetermined sterilizing material such as silver and copper is contained in the resin so as to restrain propagation of bacteria and molds adhered to the surface of the resin. The resin material in which silver is contained to conduct sterilizing/antibacterial/deodorizing functions may be called nano-poly. It is because silver particles contained in the resin are fine particles with a nano size and thus they may be sufficiently dispersed in the resin to improve sterilizing and deodorizing functions. The nano-poly may be used to make the following components of the dish washing machine: the sump 10, the filter 5, the inner panel 12 and the spoon box 4 on which spoons are placed. However, other components that may be made by shaping plastic resin may be made of such nano-poly, not limitedly.

Now, the nano-poly is further described in more detail. The nano-poly is a resin composition containing silver particles with a nano size, and the nano-poly itself has antibacterial property, charge resistance, conductivity and so on. In addition, as well known in many documents, silver (Ag) is not harmful for the human body and has antibacterial and deodorizing properties. Moreover, silver does not cause tolerance, differently from antibiotics. The sterilizing mechanism of silver is already well known in the art, and not described here in detail.

In addition, silver (Ag) is mixed with resin at a ratio of 0.1 to 50 wt % as a main component of the nano-poly, and its size is in the range of 1 nanometer to several ten nanometers. In addition, silver (Ag) particles of a nanometer unit may be mixed with the resin composition means of emulsion polymerization, dispersion polymerization or micro-emulsion polymerization. In addition, the resin may be vinyl chloride, butadiene, and acrylonitrile, and many resin materials may be used unlimitedly.

Meanwhile, the nano-poly may be used after being mixed with a general resin that is entirely composed of resin at a certain ratio, for sterilization and deodorization. In detail, a ratio of the general resin to the nano-poly used for the dish washing machine may be in the range of 1:9 to 2:8, and a predetermined sterilizing/deodorizing may be obtained by means of the mixed resin.

In addition, it is also possible to add a suitable dye or pigment when the nano-poly mixed resin is mixed with the general resin so as to realize a desired color.

Results of an antibacterial test of the mixed resin in which nano-poly and general resin are mixed are shown in the following table 1. This test was conducted in an identical way to the general resin and the nano-poly mixed resin. In detail, a plastic for test was cut into a certain size (25 cm³). Then, various kinds of strains were put into the surface of the cut plastic at a predetermined concentration. After that, a coating film (STOMACHER® 400 POLY-BAG) was covered thereon, and then static culture was conducted under a certain condition (35±1° C., RH 90%, 24 hours). After that, strain concentration was measured.

TABLE 1

| Stain | | | | |
|---|---|---|---|---|
| | Concentration | General | Nano-poly | |
| Name | of strain | resin | mixed resin | Comments |
| Strain 1 | 1.4 × 10⁵/ml | 6.4 × 10⁶/ml | 1.4 × 10⁴/ml | after 24 hrs |
| Strain 2 | 1.5 × 10⁵/ml | 7.1 × 10⁶/ml | 1.4 × 10⁴/ml | after 24 hrs |
| Strain 3 | 1.6 × 10⁵/ml | 7.2 × 10⁶/ml | 1.4 × 10⁴/ml | after 24 hrs |
| Strain 4 | 1.2 × 10⁵/ml | 5.9 × 10⁶/ml | 1.2 × 10⁴/ml | after 24 hrs |

In the table 1, the strain 1 is staphylococcus aureus, the stain 2 is klebsiella pneumoniae, the strain 3 is escherichia coli, and the stain 4 is pseudomonas aeruginosa.

Seeing the table 1, it is found that up to 99.8% of bacteria annihilated in the nano-poly mixed resin, compared with the general resin, after the experiment under the suggested condition. Such annihilation of bacteria may be expected identically for molds. In addition, due to annihilation of bacteria and molds, the deodorizing effect may also be obtained.

The bacterial put into the surface of the nano-poly mixed resin are substantially completely annihilated by the silver particles of a nano size.

In case that the aforementioned nano-poly is used for making various plastic components of the dish washing machine, propagation of bacteria and molds in the dish washing machine is restrained due to the sterilizing action of silver (Ag), thereby realizing the sterilizing/antibacterial/deodorizing functions.

In the present invention, spoiling of food remnants that are possibly adhered to inside of the dish washing machine may be restrained, there being capable of restraining propagation of bacteria and molds. In addition, bad smell possibly generated by spoiling of food remnants may be restrained. Moreover, since the sterilizing/antibacterial/deodorizing coating layer formed on various components of the dish washing machine may be used semi-permanently, so the sterilizing function may be semi-permanently realized.

In addition, since an amount of water remained on the dish shelf after the dish washing cycle is completed is reduced, energy consumption required for operating the dish washing machine is reduced. Moreover, since there is no impurity remained on the surface of dishes, a user may have better agreeableness after the dishes are washed and an image of the product is more improved. Furthermore, since an operation time of the dish washing machine is reduced, a user need not wait for a long time.

The spirit of the invention is not limited to the descried embodiments, and those skilled in the air may easily suggest other embodiments within the scope of the invention. They are also included in the spirit of the invention if they are within the range of the appended claims.

1. A dish washing machine comprising:
a cabinet having a washing room for receiving dishes therein;
an injection arm for injecting a washing water toward the dishes;
components positioned in the cabinet and contacted with the washing water;
a plasma coating layer formed on an outer surface of the components;
a heater for heating the washing water;
a air ventilation hole for discharging humid air when the dishes are dried; and
a discharge fan for forcibly flowing air through the air ventilation hole.

2. The dish washing machine according to claim 1, wherein the components include a shelf, and a plasma coating layer formed on the shelf has a hydrophilic property.

3. The dish washing machine according to claim 2, wherein a plastic coating layer having corrosion resistance is further formed on a metal portion of the shelf.

4. The dish washing machine according to claim 2, wherein a spoon box of the shelf is made of plastic, and a plasma coating layer is formed on an outer surface of the spoon box.

5. The dish washing machine according to claim 2, wherein a spoon box of the shelf has a lattice shape with horizontal and vertical rods, the horizontal rods having a greater gap than the vertical rods, a hydrophilic plasma coating layer being formed on an outer surface of the spoon box.

6. The dish washing machine according to claim 1, wherein the plasma coating layer is formed on plastic components among the components, by means of plasma generated by oxygen gas with being spaced apart at least 10 mm from an electrode in a vacuum chamber.

7. The dish washing machine according to claim 6, wherein the vacuum chamber contains mixed gas of oxygen and nitrogen.

8. The dish washing machine according to claim 6, wherein the vacuum chamber contains mixed gas of oxygen and inert gas.

9. The dish washing machine according to claim 1, wherein the components include a contaminant collector positioned below the washing room to collect contaminants in the washing water flowed thereto, the contaminant collector being coated with at least a titanium oxide coating layer.

10. The dish washing machine according to claim 9, wherein a lamp for activating the titanium oxide is included in the dish washing machine.

11. The dish washing machine according to claim 10, wherein the lamp is an ultraviolet lamp.

12. The dish washing machine according to claim 9, wherein the contaminant collector is a sump.

13. The dish washing machine according to claim 9, wherein the contaminant collector is a filter.

14. The dish washing machine according to claim 9, wherein the contaminant collector is made of nano-poly.

15. The dish washing machine according to claim 1, wherein plastic components among the components are made of nano-poly containing silver.

16. A dish washing machine comprising:
a shelf placed in an inner space of the dish washing machine so that spoons and/or dishes are seated thereon; and
a hydrophilic plasma coating layer formed on an outer surface of the shelf.

17. The dish washing machine according to claim 16, wherein, in case that the shelf is made of metal, the plasma coating layer is formed on a corrosion-resisting plastic outer coating of the shelf.

18. The dish washing machine according to claim 16, wherein a spoon box of the shelf is made of plastic, and a plasma coating layer is formed on an outer surface of the spoon box.

19. The dish washing machine according to claim 16, wherein a spoon box of the shelf has a side of a lattice shape with horizontal and vertical rods so that the horizontal rods have a greater gap than the vertical rods, a hydrophilic plasma coating layer being formed on an outer surface of the side.

20. A dish washing machine, comprising:
a cabinet for forming a washing room to wash dishes;
a shelf for receiving dishes;
an injection arm for injecting a washing water toward the dishes;
a contaminant collector positioned below the washing room to collect contaminants from the washing water that is flowed thereto, the contaminant collector being coated with at least silver and/or titanium oxide and/or copper coating layer;
an air ventilation hole for discharging air generated by action of the coating layer; and
a discharge fan for discharging the air through the air ventilation hole.

21. The dish washing machine according to claim 20, wherein the contaminant collector is a sump and/or a filter.

22. The dish washing machine according to claim 20, wherein a lamp for inducing chemical reaction to the coating layer is included.

23. The dish washing machine according to claim 20, wherein the coating layer is a plasma coating layer.

24. The dish washing machine according to claim 20, wherein the contaminant collector contains nano-poly.

25. A dish washing machine, comprising:
a cabinet for forming a washing room to wash dishes;
an inner panel provided to an inner circumference of the cabinet;
a shelf for containing dishes;
an injection arm for injecting a washing water toward the dishes;
a sump for collecting water discharged from the injection arm; and
a filter for filtering contaminants from the water collected in the sump,
wherein at least one component of the inner panel, the shelf, the injection arm, the sump and the filter is made of nano-poly.

26. The dish washing machine according to claim 25, wherein a functional plasma coating layer is formed on a surface of the component.
